(19) United States
(12) Patent Application Publication
(10) Pub. No.: US 2022/0061352 A1
(43) Pub. Date: Mar. 3, 2022

(54) METHOD FOR PRODUCING STRUCTURAL SOYBEAN-BASED MEAT ANALOGS BY USING COUETTE SHEAR FLOW-PRESSURE TANK

(71) Applicants: Hey Maet Food Technology Co., Ltd., Shanghai (CN); Northeast Agricultural University, HarBin (CN)

(72) Inventors: Xiaonan Sui, HarBin (CN); Yu Zhao, HarBin (CN); Yabo Dong, HarBin (CN); Tian Lan, HarBin (CN); Meng Li, HarBin (CN); Shujing Sun, HarBin (CN); Qin Zhang, HarBin (CN)

(21) Appl. No.: 17/462,296

(22) Filed: Aug. 31, 2021

(30) Foreign Application Priority Data
Sep. 1, 2020 (CN) 202010905807.5

(51) Int. Cl. A23J 3/16; A23J 3/22; A23J 3/18; A23J 1/14; A23J 1/12

(52) U.S. Cl. CPC A23J 3/16; A23J 3/227; A23J 1/12; A23J 1/142; A23J 3/18

(57) ABSTRACT

The present disclosure discloses a method for producing a structural soybean-based meat analog by simple shearing and heating in a Couette shear flow pressure tank, which belongs to the field of soybean protein product development. The method includes: step 1, preparing a soybean protein isolate and an active wheat gluten; step 2, preparing a sample material of protein mixture; step 3, filling the sample material of protein mixture; and step 4, carrying out a texture analysis. The present disclosure clarifies the process of applying simple shear flow and heating to soybean protein isolate and wheat gluten dispersion, provides proof of concept for the production of structural meat analogs, and confirms that the application of simple shearing and heating is the key to obtain structural plant protein products.

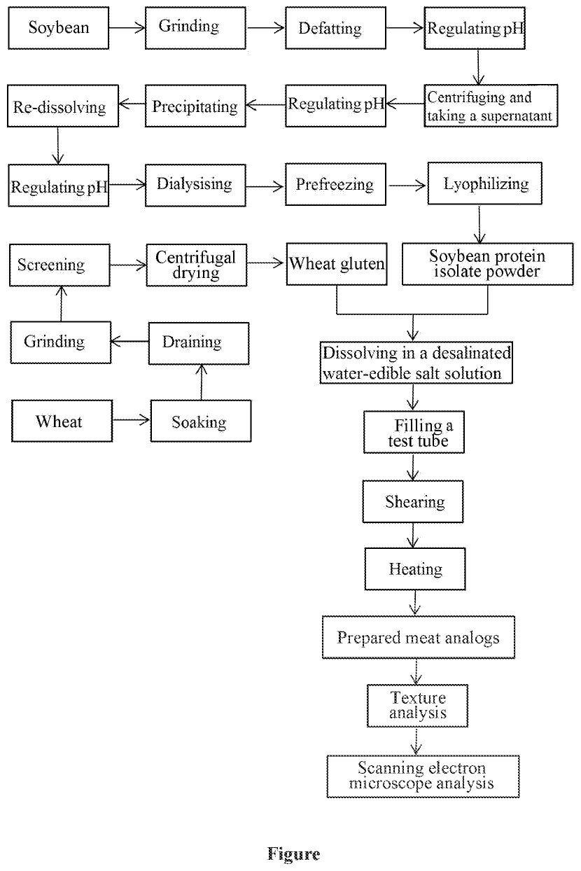

### TECHNICAL FIELD

The present disclosure belongs to the field of soybean protein product development, and mainly relates to a production of structural soybean-based meat analogs by simple shearing and heating in a Couette shear flow-pressure tank.

### BACKGROUND ART

With the world's population growing to about 7 billion, the demand for food supplies is also increasing. Meat analogs made of plant-based materials could form a sort of products that have a distinct fiber structure and are price competitive with meat. Therefore, such meat analogs will generally be accepted by consumers. Using soybean protein to prepare structural soybean meat analogs has become an active research field. However, the preparation method is of an important significance to the quality of meat analogs.

The Couette shear flow-pressure tank concept is a novel and specialized technology that produces fibrous meat analogs by applying simple shearing and heating under mild conditions. In addition, this concept allows continuous and scalable processing. The scale-up in the axial direction is very simple, and there is no need to redesign the process and equipment. The scale-up in the radial direction is more valuable because it will result in an increased thickness of the product. However, it is necessary to study the effects of rotation rate, shear force, energy input, and heating time on the internal flow and heating mode of the material as a function of the distance between the two cylinders.

In the present disclosure, structural soybean-based meat analogs are produced by using simple shearing and heating in a Couette shear flow-pressure tank. Due to the combination of simple shearing and heat, the protein is arranged into a fiber structure. The purpose of this present disclosure is not to completely optimize the operating conditions, but to prove the potential of using the Couette shear flow-pressure tank to produce anisotropic plant protein structure under mild process conditions for the first time.

### SUMMARY

The present disclosure proves for the first time the potential of using the Couette shear flow-pressure tank to produce anisotropic plant protein structure under mild process conditions, and provides a method for producing structural soybean-based meat analogs by using simple shearing and heating in a Couette shear flow-pressure tank, in which, protein is arranged into a fibrous structure through the combination of simple shearing and heat.

The technical problem to be solved by the present disclosure is achieved through the following technical solutions:

A method for producing structural soybean-based meat analogs by using a Couette shear flow-pressure tank, comprising:

step 1, mixing a defatted soybean meal with deionized water at a mass ratio of 1:15 to be uniform to obtain a mixture, regulating the mixture to a pH of 8.0 using a NaOH solution with a concentration of 2 M, and stirring at a low temperature for 2 hours during which the mixture is re-regulated to a pH of 8.0 every 30 minutes; centrifuging the mixture at a centrifugal force of 8000 g for 30 minutes to obtain a bean dreg and a supernatant, removing the bean dreg, and collecting the supernatant; then regulating the supernatant to a pH of 4.5 using a HCl solution with a concentration of 2 M, centrifuging the regulated supernatant at 6500 r/min for 20 minutes to obtain a precipitate, collecting the precipitate, and redissolving the precipitate in deionized water by regulating the mixture of the precipitate and deionized water to a pH of 7.0 until the precipitate is dissolved, to obtain a solution; placing the solution in a refrigerator at 4° C., and dialyzing with deionized water for 48 hours during which the deionized water is replaced every 12 hours, to obtain a dialyzed solution; lyophilizing the dialyzed solution to obtain a solid, and grinding the solid to obtain a soybean protein isolate powder;

step 2, soaking wheat in 2 factors the weight of a soaking liquid containing 0.5% of sulfur dioxide for 10 days, draining the soaking liquid, adding water and grinding the wheat to obtain a slurry, and then separating wheat bran from wheat germ by a screening process, separating starch grains and gluten curd by precipitation and centrifugation, and drying the gluten curd to obtain a wheat gluten:

step 3, weighing 2.0 g of edible salt and dissolving the edible salt in 138.0 g of desalinated water to obtain a desalinated water-edible salt solution; adding the desalinated water-edible salt solution to a glass beaker containing the soybean protein isolate powder therein, to obtain a mixture; manually mixing the mixture with a spatula for 1 minute, and covering the glass beaker to prevent water from escaping, and standing the mixture for 30 minutes; finally adding the wheat gluten, and then stirring with a spatula for 1 minute to obtain a soybean protein isolate-w % beat gluten mixture with a dry matter content of 31% by weight, and a mass ratio of soybean protein isolate powder to wheat gluten of 3.2:1 to 3.5:1;

step 4, filling the soybean protein isolate-wheat gluten mixture into a shearing zone by using a filling gun container, turning on a hot oil bath, and carrying out a shearing treatment under conditions of a temperature of 90° C.-110° C., an interval of 5° C., a rotation speed of 0-50 rpm, an interval of 5 rpm, a time of 5-25 minutes, an interval of 5 minutes to obtain a product; at the end of the experiment, turning off the cycle of the hot oil bath and turning on a cold oil bath to cool the product, then cutting the cooled product vertically to a plurality of samples, and measuring the weight of the samples immediately after taking them out; and

step 5, cutting three test samples parallel to the direction of the forming fiber and three test samples perpendicular to the direction of the forming fiber from each sample, and subjecting the test samples to a tensile test at a constant rate of 0.5 mm/s at ambient temperature, wherein the test samples are rectangles of 85×5.5 mm, and have a thickness of 5.5 mm.

In the method for producing structural soybean-based meat analogs by using a Couette shear flow-pressure tank, in some embodiments, the mass ratio of the soybean protein isolate powder to the wheat gluten is 3.3:1.

In the method for producing structural soybean-based meat analogs by using a Couette shear flow-pressure tank, in some embodiments, the shearing treatment is conducted at a temperature of 95° C. and at a rotation speed of 30 rpm.

In the method for producing structural soybean-based meat analogs by using a Couette shear flow-pressure tank, in some embodiments, the shearing treatment is conducted for 15 minutes.

### BRIEF DESCRIPTION OF THE DRAWINGS

FIGURE shows a process route according to an embodiment of the present disclosure.

### DETAILED DESCRIPTION OF THE EMBODIMENTS

The specific examples of the present disclosure will be described in detail below with reference to the accompanying drawings:

### Example 1

(1) A defatted soybean meal was mixed with deionized water at a mass ratio of 1:15 to be uniform, obtaining a mixture. The mixture was regulated to a pH of 8.0 using a NaOH solution with a concentration of 2 M, and stirred at ambient temperature for 2 hours during which the mixture was re-regulated to a pH of 8.0 every 30 minutes. The mixture was centrifuged at a centrifugal force of 8000 g for 30 minutes, obtaining a bean dreg and a supernatant, the bean dreg was removed, and the supernatant was collected. Then the supernatant was regulated to a pH of 4.5 using a HCl solution with a concentration of 2 M, the regulated supernatant was centrifuged at 6500 r/min for 20 minutes, obtaining a precipitate, the precipitate was collected, and the precipitate was redissolved in deionized water by regulating the mixture of the precipitate and deionized water to a pH of 7.0 until the precipitate was dissolved, obtaining a solution. The solution was placed in a refrigerator at 4° C., and dialyzed with deionized water for 48 hours during which the deionized water was replaced every 12 hours, obtaining a dialyzed solution. The dialyzed solution was lyophilized, obtaining a solid, and the solid was ground, obtaining a soybean protein isolate powder.

(2) Wheat was soaked in 2 factors the weight of a soaking liquid containing 0.5% of sulfur dioxide for 10 days, the soaking liquid was drained, water was added and the wheat was ground, obtaining a slurry, and then wheat bran from wheat germ were separated by a screening process, starch grains and gluten curd were separated by precipitation and centrifugation, and the gluten curd was dried, obtaining a wheat gluten.

(3) 2.0 g of edible salt was weighed and dissolved the edible salt in 138.0 g of desalinated water, obtaining a desalinated water-edible salt solution. The desalinated water-edible salt solution was added to a glass beaker containing the soybean protein isolate powder therein, obtaining a mixture. The mixture was manually mixed with a spatula for 1 minute, and the glass beaker was covered to prevent water from escaping, and the mixture was stood for 30 minutes. Finally the wheat gluten was added, and then stirred with a spatula for 1 minute, obtaining a soybean protein isolate-wheat gluten mixture with a dry matter content of 31% by weight, and a mass ratio of soybean protein isolate powder to wheat gluten of 3.2:1.

(4) The soybean protein isolate-wheat gluten mixture was filled into a shearing zone by using a filling gun container, a hot oil bath was turned on, and a shearing treatment was carried out at a temperature of 90° C. and a rotation speed of 10 rpm for 10 minutes, obtaining a product. At the end of the experiment, the cycle of the hot oil bath was turned off and a cold oil bath was turned on to cool the product, then the cooled product was cut vertically to a plurality of samples, and the weight of the samples was immediately weighed after taking them out.

(5) Three test samples parallel to the direction of the forming fiber and three test samples perpendicular to the direction of the forming fiber were cut from each sample, and the test samples were subjected to a tensile test at a constant rate of 0.5 mm/s at ambient temperature, wherein the test samples were rectangles of 85-5.5 mm, and have a thickness of 5.5 mm.

It is evident that no obvious anisotropic structure was observed in this meat analog.

### Example 2

(1) A defatted soybean meal was mixed with deionized water at a mass ratio of 1:15 to be uniform, obtaining a mixture. The mixture was regulated to a pH of 8.0 using a NaOH solution with a concentration of 2 M, and stirred at ambient temperature for 2 hours during which the mixture was re-regulated to a pH of 8.0 every 30 minutes. The mixture was centrifuged at a centrifugal force of 8000 g for 30 minutes, obtaining a bean dreg and a supernatant, the bean dreg was removed, and the supernatant was collected. Then the supernatant was regulated to a pH of 4.5 using a HCl solution with a concentration of 2 M, the regulated supernatant was centrifuged at 6500 r/min for 20 minutes, obtaining a precipitate, the precipitate was collected, and the precipitate was redissolved in deionized water by regulating the mixture of the precipitate and deionized water to a pH of 7.0 until the precipitate was dissolved, obtaining a solution. The solution was placed in a refrigerator at 4° C., and dialyzed with deionized water for 48 hours during which the deionized water was replaced every 12 hours, obtaining a dialyzed solution. The dialyzed solution was lyophilized, obtaining a solid, and the solid was ground, obtaining a soybean protein isolate powder.

(2) Wheat was soaked in 2 factors the weight of a soaking liquid containing 0.5% of sulfur dioxide for 10 days, the soaking liquid was drained, water was added and the wheat was ground, obtaining a slurry, and then wheat bran from wheat germ were separated by a screening process, starch grains and gluten curd were separated by precipitation and centrifugation, and the gluten curd was dried, obtaining a wheat gluten.

(3) 2.0 g of a edible salt was weighed and dissolved the edible salt in 138.0 g of desalinated water, obtaining a desalinated water-edible salt solution. The desalinated water-edible salt solution was added to a glass beaker containing the soybean protein isolate powder therein, obtaining a mixture. The mixture was manually mixed with a spatula for 1 minute, and the glass beaker was covered to prevent water from escaping, and the mixture was stood for 30 minutes. Finally the wheat gluten was added, and then stirred with a spatula for 1 minute, obtaining a soybean protein isolate-wheat gluten mixture with a dry matter content of 31% by weight, and a mass ratio of soybean protein isolate powder to wheat gluten of 3.3:1.

(4) The soybean protein isolate-wheat gluten mixture was filled into a shearing zone by using a filling gun container, a hot oil bath was turned on, and a shearing treatment was carried out at a temperature of 95° C. and a rotation speed of 30 rpm for 15 minutes, obtaining a product. At the end of the experiment, the cycle of the hot oil bath was turned off and a cold oil bath was turned on to cool the product, then the cooled product was cut vertically to a plurality of samples, and the weight of the samples was immediately weighed after taking them out.

(5) Three test samples parallel to the direction of the forming fiber and three test samples perpendicular to the direction of the forming fiber were cut from each sample, and the test samples were subjected to a tensile test at a constant rate of 0.5 mm/s at ambient temperature, wherein the test samples were rectangles of 85-5.5 mm, and have a thickness of 5.5 mm.

It can be seen from this meat analog that a single test sample with a clear fiber structure has a high tensile stress anisotropy index. These results confirm an intuitive expectation that the tensile strength will be higher in the direction parallel to the fiber.

### Example 3

(1) A defatted soybean meal was mixed with deionized water at a mass ratio of 1:15 to be uniform, obtaining a mixture. The mixture was regulated to a pH of 8.0 using a NaOH solution with a concentration of 2 M, and stirred at ambient temperature for 2 hours during which the mixture was re-regulated to a pH of 8.0 every 30 minutes. The mixture was centrifuged at a centrifugal force of 8000 g for 30 minutes, obtaining a bean dreg and a supernatant, the bean dreg was removed, and the supernatant was collected. Then the supernatant was regulated to a pH of 4.5 using a HCl solution with a concentration of 2 M, the regulated supernatant was centrifuged at 6500 r/min for 20 minutes, obtaining a precipitate, the precipitate was collected, and the precipitate was redissolved in deionized water by regulating the mixture of the precipitate and deionized water to a pH of 7.0 until the precipitate was dissolved, obtaining a solution. The solution was placed in a refrigerator at 4° C., and dialyzed with deionized water for 48 hours during which the deionized water was replaced every 12 hours, obtaining a dialyzed solution. The dialyzed solution was lyophilized, obtaining a solid, and the solid was ground, obtaining a soybean protein isolate powder.

(2) Wheat was soaked in 2 factors the weight of a soaking liquid containing 0.5% of sulfur dioxide for 10 days, the soaking liquid was drained, water was added and the wheat was ground, obtaining a slurry, and then wheat bran from wheat germ were separated by a screening process, starch grains and gluten curd were separated by precipitation and centrifugation, and the gluten curd was dried, obtaining a wheat gluten.

(3) 2.0 g of edible salt was weighed and dissolved the edible salt in 138.0 g of desalinated water, obtaining a desalinated water-edible salt solution. The desalinated water-edible salt solution was added to a glass beaker containing the soybean protein isolate powder therein, obtaining a mixture. The mixture was manually mixed with a spatula for 1 minute, and the glass beaker was covered to prevent water from escaping, and the mixture was stood for 30 minutes. Finally the wheat gluten was added, and then stirred with a spatula for 1 minute, obtaining a soybean protein isolate-wheat gluten mixture with a dry matter content of 31% by weight, and a mass ratio of soybean protein isolate powder to wheat gluten of 3.4:1.

(4) The soybean protein isolate-wheat gluten mixture was filled into a shearing zone by using a filling gun container, a hot oil bath was turned on, and a shearing treatment was carried out at a temperature of 100° C. and a rotation speed of 40 rpm for 20 minutes, obtaining a product. At the end of the experiment, the cycle of the hot oil bath was turned off and a cold oil bath was turned on to cool the product, then the cooled product was cut vertically to a plurality of samples, and the weight of the samples was immediately weighed after taking them out.

(5) Three test samples parallel to the direction of the forming fiber and three test samples perpendicular to the direction of the forming fiber were cut from each sample, and the test samples were subjected to a tensile test at a constant rate of 0.5 mm/s at ambient temperature, wherein the test samples were rectangles of 85×5.5 mm, and have a thickness of 5.5 mm.

It is evident that the meat analog sometimes forms obvious fibers, while in other cases, samples with a layered or even isotropic structure and bubbles formed throughout the area are obtained.

### Example 4

(1) A defatted soybean meal was mixed with deionized water at a mass ratio of 1:15 to be uniform, obtaining a mixture. The mixture was regulated to a pH of 8.0 using a NaOH solution with a concentration of 2 M, and stirred at ambient temperature for 2 hours during which the mixture was re-regulated to a pH of 8.0 every 30 minutes. The mixture was centrifuged at a centrifugal force of 8000 g for 30 minutes, obtaining a bean dreg and a supernatant, the bean dreg was removed, and the supernatant was collected. Then the supernatant was regulated to a pH of 4.5 using a HCl solution with a concentration of 2 M, the regulated supernatant was centrifuged at 6500 r/min for 20 minutes, obtaining a precipitate, the precipitate was collected, and the precipitate was redissolved in deionized water by regulating the mixture of the precipitate and deionized water to a pH of 7.0 until the precipitate was dissolved, obtaining a solution. The solution was placed in a refrigerator at 4° C., and dialyzed with deionized water for 48 hours during which the deionized water was replaced every 12 hours, obtaining a dialyzed solution. The dialyzed solution was lyophilized, obtaining a solid, and the solid was ground, obtaining a soybean protein isolate powder.

(2) Wheat was soaked in 2 factors the weight of a soaking liquid containing 0.5% of sulfur dioxide for 10 days, the soaking liquid was drained, water was added and the wheat was ground, obtaining a slurry, and then wheat bran from wheat germ were separated by a screening process, starch grains and gluten curd were separated by precipitation and centrifugation, and the gluten curd was dried, obtaining a wheat gluten.

(3) 2.0 g of edible salt was weighed and dissolved the edible salt in 138.0 g of desalinated water, obtaining a desalinated water-edible salt solution. The desalinated water-edible salt solution was added to a glass beaker containing the soybean protein isolate powder therein, obtaining a mixture. The mixture was manually mixed with a spatula for 1 minute, and the glass beaker was covered to prevent water from escaping, and the mixture was stood for 30 minutes. Finally the wheat gluten was added, and then stirred with a spatula for 1 minute, obtaining a soybean protein isolate-wheat gluten mixture with a dry matter content of 31% by weight, and a mass ratio of soybean protein isolate powder to wheat gluten of 3.5:1.

(4) The soybean protein isolate-wheat gluten mixture was filled into a shearing zone by using a filling gun container, a hot oil bath was turned on, and a shearing treatment was carried out at a temperature of 110° C. and a rotation speed of 50 rpm for 25 minutes, obtaining a product. At the end of the experiment, the cycle of the hot oil bath was turned off and a cold oil bath was turned on to cool the product, then the cooled product was cut vertically to a plurality of samples, and the weight of the samples was immediately weighed after taking them out.

(5) Three test samples parallel to the direction of the forming fiber and three test samples perpendicular to the direction of the forming fiber were cut from each sample, and the test samples were subjected to a tensile test at a constant rate of 0.5 mm/s at ambient temperature, wherein the test samples were rectangles of 85-5.5 mm, and have a thickness of 5.5 mm.

It is evident that most of the meat analogs are deformed or have no obvious anisotropic structure, bubbles will also be formed in the samples, and the anisotropy index of stress and strain are reduced.

What is claimed is:

1. A method for producing structural soybean-based meat analogs by using a Couette shear flow-pressure tank, comprising
step 1, mixing a defatted soybean meal with deionized water at a mass ratio of 1:15 to be uniform to obtain a mixture, regulating the mixture to a pH of 8.0 using a NaOH solution with a concentration of 2 M, and stirring at a low temperature for 2 hours during which the mixture is re-regulated to a pH of 8.0 every 30 minutes, centrifuging the mixture at a centrifugal force of 8000 g for 30 minutes to obtain a bean dreg and a supernatant, removing the bean dreg, and collecting the supernatant; then regulating the supernatant to a pH of 4.5 using a HCl solution with a concentration of 2 M, centrifuging the regulated supernatant at 6500 r/min for 20 minutes to obtain a precipitate, collecting the precipitate, and redissolving the precipitate in deionized water by regulating the mixture of the precipitate and deionized water to a pH of 7.0 until the precipitate is dissolved, to obtain a solution; placing the solution in a refrigerator at 4° C., and dialyzing with deionized water for 48 hours during which the deionized water is replaced every 12 hours, to obtain a dialyzed solution; lyophilizing the dialyzed solution to obtain a solid, and grinding the solid to obtain a soybean protein isolate powder;
step 2, soaking wheat in 2 factors the weight of a soaking liquid containing 0.5% of sulfur dioxide for 10 days, draining the soaking liquid, adding water and grinding the wheat to obtain a slurry, and then separating wheat bran from wheat germ by a screening process, separating starch grains and gluten curd by precipitation and centrifugation, and drying the gluten curd to obtain a wheat gluten;
step 3, weighing 2.0 g of edible salt and dissolving the edible salt in 138.0 g of desalinated water to obtain a desalinated water-edible salt solution; adding the desalinated water-edible salt solution to a glass beaker containing the soybean protein isolate powder therein, to obtain a mixture; manually mixing the mixture with a spatula for 1 minute, and covering the glass beaker to prevent water from escaping, and standing the mixture for 30 minutes; finally adding the wheat gluten, and then stirring with a spatula for 1 minute to obtain a soybean protein isolate-wheat gluten mixture with a dry matter content of 31% by weight, and a mass ratio of soybean protein isolate powder to wheat gluten of 3.2:1 to 3.5:1;
step 4, filling the soybean protein isolate-wheat gluten mixture into a shearing zone by using a filling gun container, turning on a hot oil bath, and carrying out a shearing treatment under conditions of a temperature of 90° C.-110° C., an interval of 5° C., a rotation speed of 0-50 rpm, an interval of 5 rpm, a time of 5-25 minutes, an interval of 5 minutes to obtain a product; at the end of the experiment, turning off the cycle of the hot oil bath and turning on a cold oil bath to cool the product, then cutting the cooled product vertically to a plurality of samples, and measuring the weight of the samples immediately after taking them out; and
step 5, cutting three test samples parallel to the direction of the forming fiber and three test samples perpendicular to the direction of the forming fiber from each sample, and subjecting the test samples to a tensile test at a constant rate of 0.5 mm/s at ambient temperature, wherein the test samples are rectangles of 85-5.5 mm, and have a thickness of 5.5 mm.

2. The method for producing structural soybean-based meat analogs by using a Couette shear flow-pressure tank of claim 1, wherein the mass ratio of the soybean protein isolate powder to the wheat gluten is 3.3:1.

3. The method for producing structural soybean-based meat analogs by using a Couette shear flow-pressure tank of claim 1, wherein the shearing treatment is conducted at a temperature of 95° C. and at a rotation speed of 30 rpm.

4. The method for producing structural soybean-based meat analogs by using a Couette shear flow-pressure tank of claim 1, wherein the shearing treatment is conducted for 15 minutes.
